(19) United States
(12) Patent Application Publication
(10) Pub. No.: US 2023/0245468 A1
(43) Pub. Date: Aug. 3, 2023

(54) IMAGE PROCESSING DEVICE, MOBILE OBJECT CONTROL DEVICE, IMAGE PROCESSING METHOD, AND STORAGE MEDIUM

(71) Applicant: HONDA MOTOR CO., LTD., Tokyo (JP)

(72) Inventor: Masamitsu Tsuchiya, Wako-shi (JP)

(21) Appl. No.: 18/099,996

(22) Filed: Jan. 23, 2023

(30) Foreign Application Priority Data
Jan. 31, 2022 (JP) 2022-012904

(51) Int. Cl. G06V 20/58; G06T 7/70; G06V 10/74; G05D 1/02

(52) U.S. Cl. CPC G06V 20/58; G06T 7/70; G06V 10/761; G05D 1/021; G06V 2201/07; G06T 2207/30256

(57) ABSTRACT

An image processing device of the embodiment includes an acquirer configured to acquire a first image captured in time series by an imager mounted on a mobile object, a setter configured to set one or more positions of interest based on a position of the mobile object in the first image, a converter configured to convert a partial image set on the basis of the position of interest set by the setter into a second image, and a target detector configured to detect a target near the mobile object on the basis of the second image obtained by the conversion by the converter, in which the setter changes the position of interest on the basis of at least one of a result of detection by the target detector and a situation of the mobile object.

### CROSS-REFERENCE TO RELATED APPLICATION

Priority is claimed on Japanese Patent Application No. 2022-012904, filed Jan. 31, 2022, the content of which is incorporated herein by reference.

### BACKGROUND

### Field of the Invention

The present invention relates to an image processing device, a mobile object control device, an image processing method, and a storage medium.

### Description of Related Art

Conventionally, a technology for recognizing the surroundings of a vehicle using an image captured by a camera mounted in the vehicle and using a result of the recognition for control such as driving assistance is known. In addition, conventionally, a technology using a fish-eye camera using a fish-eye lens to widen a detection range of the surroundings is known (for example, Japanese Unexamined Patent Application, First Publication No. 2021-004017).

### SUMMARY

However, with the conventional technologies, an image captured by the fish-eye camera is greatly distorted due to an influence of the fish-eye lens or the like, and there have been cases in which the shape, size, or the like of a target in the image cannot be recognized with high accuracy from the captured image as it is. Correcting the distortion of the image captured by the fish-eye camera and using it for object recognition can also be considered, but the load of image processing increases because an image range to be captured is a wide range, and the image of the fish-eye camera may not be appropriate in a situation in which it is necessary to quickly detect nearby targets in some cases.

Aspects of the present invention have made in consideration of such circumstances, and one object thereof is to provide an image processing device, a mobile object control device, an image processing method, and a storage medium that can perform more appropriate image processing on camera images.

An image processing device, a mobile object control device, an image processing method, and a storage medium according to the present invention have adopted the following configuration.

(1): An image processing device according to one aspect of the present invention includes an acquirer configured to acquire a first image captured in time series by an imager mounted on a mobile object, a setter configured to set one or more positions of interest based on a position of the mobile object in the first image, a converter configured to convert a partial image set on the basis of the position of interest set by the setter into a second image, and a target detector configured to detect a target near the mobile object on the basis of the second image obtained by the conversion by the converter, in which the setter changes the position of interest on the basis of at least one of a result of detection by the target detector and a situation of the mobile object.

(2): In the aspect of (1) described above, the setter changes the position of interest when a predetermined target is not detected in the second image based on the past first image captured by the imager to a position farther than a position of interest when a target is detected from the second image by a predetermined distance or more.

(3): In the aspect of (1) described above, the setter does not change the position of interest when a predetermined target is detected in the second image based on the past first image captured by the imager.

(4): In the aspect of (3) described above, the predetermined target includes an oncoming mobile object that travels toward the mobile object.

(5): In the aspect of (1) described above, when an angular speed of the mobile object is equal to or greater than a predetermined angle, the setter causes the position of interest to move horizontally according to the angular speed.

(6): In the aspect of (2) described above, the position farther by the predetermined distance or more includes a position within a predetermined distance from a lane adjacent to a lane in which the mobile object travels.

(7): In the aspect of (2) described above, the position farther by the predetermined distance or more includes a position within a predetermined distance from a lane farthest from the mobile object among lanes detectable by the target detector.

(8): In the aspect of (1) described above, the target is a target that may deviate from the lane in which the mobile object is traveling.

(9): A mobile object control device according to another aspect of the present invention includes the image processing device according to claim 1, and a driving controller configured to control one or both of steering and speed of the mobile object on the basis of a result of processing by the image processing device.

(10): An image processing method according to still another aspect of the present invention includes, by a computer, acquiring a first image captured in time series by an imager mounted on a mobile object, setting one or more positions of interest based on a position of the mobile object in the first image, converting a partial image set on the basis of the set position of interest into a second image, detecting a target near the mobile object on the basis of the converted second image, and changing the position of interest on the basis of at least one of a result of the detection and a situation of the mobile object.

(11): A storage medium according to still another aspect of the present invention is a computer-readable non-transitory storage medium which has stored a program causing a computer to execute acquiring a first image captured in time series by an imager mounted on a mobile object, setting one or more positions of interest based on a position of the mobile object in the first image, converting a partial image set on the basis of the set position of interest into a second image, detecting a target near the mobile object on the basis of the converted second image, and changing the position of interest on the basis of at least one of a result of the detection and a situation of the mobile object.

According to the aspects of (1) to (11) described above, it is possible to perform more appropriate mobile object control.

### BRIEF DESCRIPTION OF THE DRAWINGS

FIG. 1 is a configuration diagram of a vehicle system including an image processing device according to an embodiment.

FIG. 2 is a diagram for describing an imaging range of a camera.

FIG. 3 is a diagram for describing a function of an image processor.

FIG. 4 is a diagram for describing changing of a position of interest.

FIG. 5 is a diagram for describing setting of a conversion center position when an oncoming vehicle is detected.

FIG. 6 is a flowchart which shows an example of a flow of processing executed by a vehicle control device.

FIG. 7 is a flowchart which shows an example of a flow of image processing according to an embodiment.

FIG. 8 is a flowchart which shows an example of processing of setting a position of interest.

### DESCRIPTION OF EMBODIMENTS

Hereinafter, embodiments of an image processing device, a mobile object control device, an image processing method, and a storage medium of the present invention will be described with reference to the drawings. In the following description, an example in which the image processing device is mounted on a mobile object will be described. A mobile object is, for example, a structure that can be moved by its own drive mechanism, such as a vehicle, micro-mobility, an autonomous mobile robot, a ship, or a drone. In the following description, it is assumed that the mobile object is a vehicle that moves on the ground, and only the configuration and functions for causing the vehicle to move on the ground will be described. “Controlling a mobile object” means, for example, giving advice on a driving operation by voice, display, or the like, or performing interference control to some extent with manual driving set as a main driving. Controlling a mobile object includes controlling, at least temporarily, one or both of the steering and speed of the mobile object to cause the mobile object to move autonomously, or controlling activation of a protective device that protects an occupant of the mobile object.

[Overall Configuration]

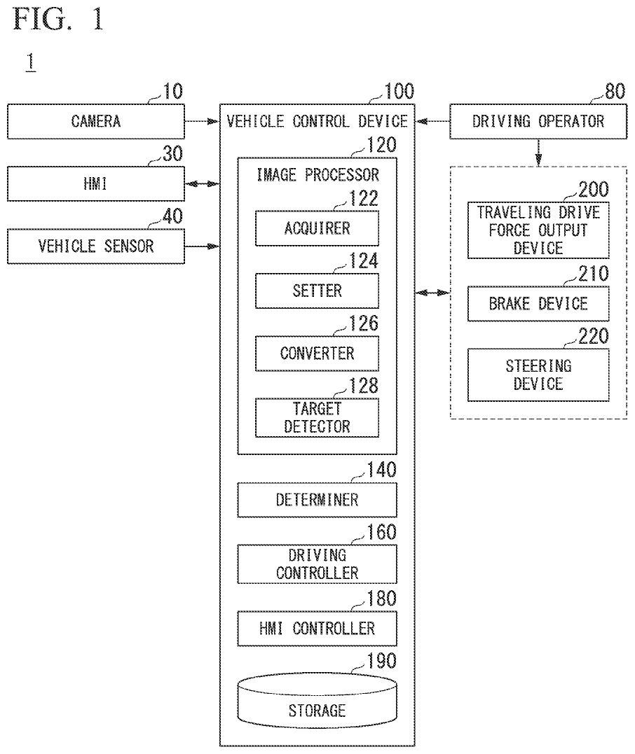

FIG. 1 is a configuration diagram of a vehicle system 1 including an image processing device according to an embodiment. A vehicle on which the vehicle system 1 is mounted (hereinafter referred to as a host vehicle M) is, for example, a two-wheeled, three-wheeled, or four-wheeled vehicle, and a drive source thereof is an internal combustion engine such as a diesel engine or a gasoline engine, an electric motor, or a combination thereof. An electric motor operates using power generated by a generator connected to the internal combustion engine, or using power discharged from a secondary battery or fuel cell.

The vehicle system 1 includes, for example, a camera 10, a human machine interface (HMI) 30, a vehicle sensor 40, a driving operator 80, a vehicle control device 100, a traveling drive force output device 200, a brake device 210, and a steering device 220. These devices and apparatuses are connected to each other by multiplex communication lines such as controller area network (CAN) communication lines, serial communication lines, wireless communication networks, and the like. The configuration shown in FIG. 1 is merely an example, and a part of the configuration may be omitted, or another configuration may be further added. The camera 10 is an example of an “imager (image sensor).” The HMI 30 is an example of an “output section.” The vehicle control device 100 is an example of a “mobile object control device.”

The camera 10 captures an image of surroundings of the host vehicle M. The camera 10 is, for example, a camera capable of capturing a wide-angle (for example, 360 degrees) image of the surroundings of the host vehicle M. The camera 10 is, for example, a camera provided with a wide-angle lens or a fish-eye lens, and is called a so-called wide-angle camera or fish-eye camera. The camera 10 is attached to, for example, a top of the mobile object M, and captures the wide-angle image of the surroundings of the mobile object M in a horizontal direction. The camera 10 may be realized by combining a plurality of cameras (a plurality of cameras that capture images in a range of about 60 to 180 degrees in the horizontal direction), or may have a standard camera.

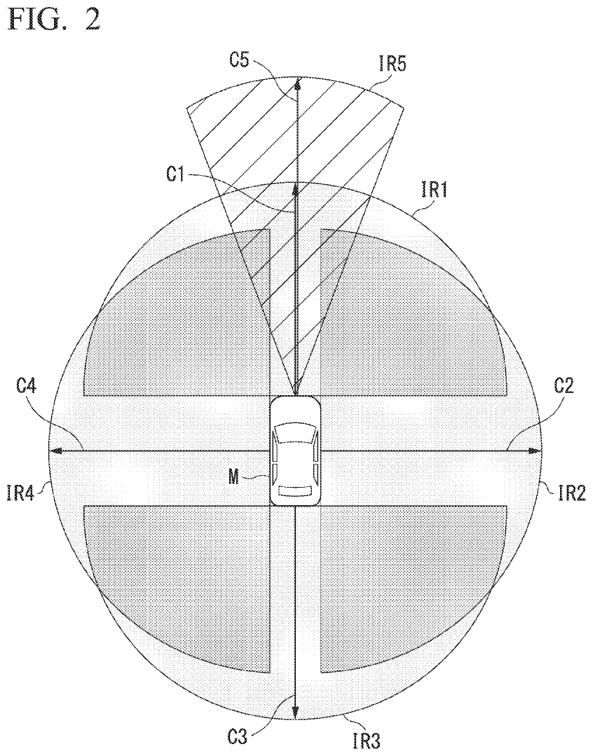

FIG. 2 is a diagram for describing an imaging range of the camera 10. In the example of FIG. 2, imaging ranges of fish-eye cameras attached to the front, rear, left, and right of the host vehicle M and a standard camera attached to an arbitrary position (for example, a front center of the host vehicle M) for photographing the front of the host vehicle M in the horizontal direction are shown. The fish-eye camera attached to the front of the host vehicle M photographs, for example, scenery included in an imaging range IR1. A center C1 of the imaging range IR1 faces directly in front of the host vehicle M. A fish-eye camera attached to a right side of the host vehicle M photographs scenery included in an imaging range IR2. A center C2 of the imaging range IR2 faces directly to beside the right of the host vehicle M. A fish-eye camera attached to the rear of the host vehicle M photographs scenery included in an imaging range IR3. A center C3 of the imaging range IR3 faces directly behind the host vehicle M. A fish-eye camera attached to the left side of the host vehicle M photographs scenery included in an imaging range IR4. A center C4 of the imaging range IR4 faces directly to the left of the host vehicle M. In the example of FIG. 2, a horizontal angle of view of each fish-eye camera is approximately 180 degrees, but the present invention is not limited thereto. The standard camera photographs scenery included in an imaging range IR5. A center 200C of the imaging range IR5 faces directly in front of the host vehicle M. A horizontal angle of view of the standard camera is approximately 30 degrees, but the present invention is not limited thereto.

In addition to the camera 10 described above, the host vehicle M may be equipped with a radar device that detects a target, light detection and ranging (LIDAR), sonar, and the like. The camera 10, the radar device, the LIDAR, and the sonar are examples of external sensors that recognize a surrounding situation of the host vehicle M. By periodically and repeatedly capturing images of the surroundings of the host vehicle M by the camera 10, time-series images are captured. Image data including a plurality of image frames captured in time series by the camera 10 is output to the vehicle control device 100.

The HMI 30 presents various types of information to an occupant of the host vehicle M under control of the HMI controller 180 and receives an input operation by the occupant. The HMI 30 includes, for example, various display devices, speakers, switches, microphones, buzzers, touch panels, keys, and the like. Various display devices are, for example, liquid crystal display (LCD) and organic electro luminescence (EL) display devices, and the like. The display device is provided, for example, near a front of a driver's seat (a seat closest to a steering wheel) in an instrument panel, and is installed at a position where the occupant can see it through a gap between steering wheels or through the steering wheels. The display device may be installed in a center of the instrument panel. The display device may be a head up display (HUD). By projecting an image onto a part of the windshield in front of the driver's seat, the HUD causes a virtual image to be visible to the eyes of the occupant seated on the driver's seat. The display device displays an image generated by the HMI controller 180, which will be described below.

The vehicle sensor 40 includes a vehicle speed sensor for detecting a speed of the host vehicle M, an acceleration sensor for detecting an acceleration, a yaw rate sensor for detecting an angular speed around a vertical axis, an orientation sensor for detecting a direction of the host vehicle M, and the like. The vehicle sensor 40 may also include a steering angle sensor that detects a steering angle of the host vehicle M (may be either an angle of the steering wheel or an operation angle of the steering wheel). The vehicle sensor 40 may also include a position sensor that acquires a position of the host vehicle M. The position sensor is, for example, a sensor that acquires position information (longitude and latitude information) from a global positioning system (GPS) device. The position sensor may be, for example, a sensor that acquires position information using a global navigation satellite system (GNSS) receiver of a navigation device (not shown) mounted in the host vehicle M.

The driving operator 80 includes, for example, a steering wheel, an accelerator pedal, a brake pedal, a shift lever, and other operators. The operator does not necessarily have to be annular, and may be in a form of a deformed steering wheel, joystick, button, or the like. The driving operator 80 is equipped with a sensor that detects the amount of operations or the presence or absence of an operation, and a result of the detection is output to the vehicle control device 100 or some or all of the traveling drive force output device 200, the brake device 210, and the steering device 220.

The vehicle control device 100 includes, for example, an image processor 120, a determiner 140, a driving controller 160, a HMI controller 180, and a storage 190. Each of the image processor 120, the driving controller 160, and the HMI controller 180 are realized by, for example, a hardware processor such as a central processing unit (CPU) executing a program (software). Some or all of these components may be realized by hardware (circuit unit; including circuitry) such as large scale integration (LSI), an application specific integrated circuit (ASIC), a field-programmable gate array (FPGA), a graphics processing unit (GPU), and the like, or by software and hardware in cooperation. The program may be stored in advance in a storage device such as an HDD of the vehicle control device 100 or flash memory (a storage device with a non-transitory storage medium), or may be stored in a detachable storage medium such as a DVD or CD-ROM and may be installed in the HDD of the vehicle control device 100 or flash memory by the storage medium (a non-transitory storage medium) being mounted on a drive device. The image processor 120 is an example of the “image processing device.” The HMI controller 180 is an example of an “output controller.”

The storage 190 may be realized by the various storage devices described above, a solid state drive (SSD), an electrically erasable programmable read only memory (EEPROM), a read only memory (ROM), or a random access memory (RAM). The storage 190 stores, for example, images captured by the camera 10 (time-series surrounding images), map information, programs, and various types of other information. The map information may include, for example, a road shape (road width, curvature, gradient), the number of lanes, intersections, information on a lane center or information on a lane boundary (a marking line), and the like. The map information may include Point Of Interest (POI) information, traffic regulation information, address information (address/zip code), facility information, telephone number information, and the like.

The image processor 120 performs predetermined image processing and the like on an image captured by the camera 10 (hereinafter referred to as a camera image). A camera image is an example of a “first image.” The imaging range included in the camera image is at least one of the imaging ranges IR1 to IR5 shown in FIG. 2. The image processor 120 includes, for example, an acquirer 122, a setter 124, a converter 126, and a target detector 128.

The acquirer 122 acquires camera images captured by the camera 10 in time series. The acquirer 122 may store the acquired camera images in the storage 190 or the like.

The setter 124 sets one or more positions of interest in the camera image acquired by the acquirer 122. The position of interest is, for example, a conversion center point when the converter 126 performs image conversion on the image captured by the fish-eye camera. The conversion center point is, for example, a point associated with a direction from the host vehicle M and a distance from the host vehicle M on the camera image. The conversion center point may be set according to, for example, a situation of the host vehicle M (for example, the position of the host vehicle M, and behavior such as speed and angular speed), a shape of a road on which the host vehicle M travels, and the like.

The setter 124 sets one or more positions of interest in the camera image, and sets one or more partial images for each set position of interest. A shape of the partial image is, for example, a rectangle, but may be another shape (for example, circular, or the like). A size of a partial image area may be fixed or may be variably set according to a position and a direction of the set position of interest. When the size of the partial image area is set according to the position and direction of the set position of interest, for example, the setter 124 set the size of the partial image area on the basis of a size of other vehicle assumed when it is assumed that the other vehicle is detected near the set position of interest.

The setter 124 changes the position of interest on the basis of at least one of a result of the detection by the target detector 128 for a partial image corresponding to a camera image captured at a past time and the situation of the host vehicle M.

The converter 126 performs, for example, predetermined image processing such as distortion correction processing on the partial image based on the conversion center point set by the setter 124 in the camera image acquired by the acquirer 122, and converts it into a normalized image that is normalized by reducing distortion. A normalized image is an example of a “second image.” For example, the converter 126 may perform distortion correction by performing coordinate conversion, interpolation calculation, or the like using calibration data, distortion model data, and the like prepared in advance, or may also perform distortion correction of the partial image using other known distortion correction algorithms Through the distortion correction processing, distortion is reduced at a position closer to the conversion center point, and distortion is not reduced but increased at a position farther from the conversion center point. Therefore, in the setter 124, by setting a conversion center point at a point of particular interest in the camera image (for example, a point on a road in front of, beside, or behind the host vehicle M), a corrected image with the distortion reduced is generated in a corresponding area.

The converter 126 may synthesize a plurality of normalized images for partial images associated with a plurality of positions of interest. In this case, since a distance and an angle from a center of an imaging range of each partial image (each position of interest) (in other words, the distance from the host vehicle M and the angle from the front direction of the host vehicle M) are different, differences may occur in a result of correction. For this reason, the converter 126 may perform conversion for adjusting these errors (for example, conversion for adjusting enlargement, reduction, and the like according to an image size, a resolution, and a distance). Accordingly, it possible to generate a normalized image that is more suitable for target detection.

The target detector 128 detects a target near (surroundings) the host vehicle M by using the normalized image obtained by the conversion by the converter 126. For example, the target detector 128 recognizes a position (relative position), a speed (relative speed), and the like of the target near the host vehicle M included in the normalized image. The target includes, for example, objects such as other vehicles (for example, surrounding vehicles present within a predetermined distance from the host vehicle M), pedestrians, bicycles, and road structures. Road structures include, for example, road signs, traffic lights, curbs, medians, guardrails, fences, walls, railroad crossings, and the like. The position of the target is recognized as, for example, a position on absolute coordinates with a representative point (a center of gravity, a center of a drive shaft, or the like) of the host vehicle M as an origin, and used for control. The position of the target may be represented by a representative point such as the center of gravity or a corner of the target, or by an expressed area. For example, when the target is other vehicle, a “state” of the target may include an acceleration or jerk, or a “behavior state” (for example, whether it is changing lanes or is about to change lanes) of the other vehicle. The target may include a road marking line (hereinafter referred to as a marking line) that partitions each lane included in the road on which the vehicle M travels and the traveling lane in which the vehicle M travels. The target detector 128 may determine whether the other vehicle is an oncoming vehicle (an example of an oncoming mobile object) based on behavior of the host vehicle M and the other vehicle.

For example, the target detector 128 performs image analysis on the normalized image, acquires feature information (for example, feature information based on color, size, shape, and the like) for each target included in an image, and detects a target included in the image by matching processing between the acquired feature information and feature information of a predetermined target. Detection of the target may include, for example, determination processing by artificial intelligence (AI) or machine learning. In this manner, since target detection is performed by using a normalized image with reduced distortion, various objects, signs, and the like can be detected with higher accuracy. In the embodiment, since conversion processing and target detection are performed on a partial image, target detection can be performed more quickly than when an entire photographing range of a fish-eye camera is used.

Based on a result of the processing by the image processor 120, the determiner 140 determines whether a target requiring driving control (driving assistance) of the host vehicle M is present around the host vehicle M on the basis of a result of the processing by the image processor 120. For example, the determiner 140 derives a relative distance and a relative speed between the target and the vehicle M on the basis of the position and speed of the target detected by the image processor 120 and the position and speed of the vehicle M obtained from the vehicle sensor 40, and determines whether there is a possibility that the host vehicle M and the target will come into contact with each other in the future on the basis of the derived information. In the following description, as an example, it is assumed that the target is the other vehicle.

For example, the determiner 140 acquires a relative position and a relative speed between the host vehicle M and another vehicle on the basis of the position and speed of the vehicle M detected by the vehicle sensor 40, or the like, and the position and speed of the other vehicle detected by the target detector 128. Then, the determiner 140 derives a contact margin time TTC (Time To Collision) using the relative position (relative distance) and the relative speed between the host vehicle M and other vehicle m1 traveling on a lane L2, and determines whether the derived contact margin time TTC (Time To Collision) is less than a threshold value. The contact margin time TTC is, for example, a value calculated by dividing the relative distance by the relative speed. The contact margin time TTC may be, for example, a fixed value, or may be a variable value set according to a speed VM of the host vehicle M, speeds of other vehicles, road situations, and the like.

When the contact margin time TTC is less than the threshold value, the determiner 140 determines that there is a possibility of contact between the host vehicle M and other vehicle, and when the contact margin time is equal to or greater than the threshold value, it determines that there is no possibility of contact.

The driving controller 160 controls one or both of steering and speed of the host vehicle M and controls the traveling of the host vehicle M to avoid contact when the determiner 140 determines that the host vehicle M and another vehicle may come into contact with each other. For example, the driving controller 160 executes avoidance control such as control for causing the host vehicle M to suddenly stop by controlling the brake device 210 or control for causing the host vehicle M to suddenly accelerate by controlling the traveling drive force output device 200. The driving controller 160 may execute the avoidance control for causing the host vehicle M to move away from other vehicle according to steering control by controlling the steering device 220 instead of (or in addition to) sudden stop or sudden acceleration.

In addition to the control described above, the driving controller 160 may also perform, for example, driving assistance control to assist with a driving operation performed by the driver when the driver causes the host vehicle M to travel, such as adaptive cruise control (ACC), a lane keeping assist system (LKAS), and auto lane changing (ALC) on the basis of a result of the detection by the target detector 128.

The HMI controller 180 uses the HMI 30 to notify the occupant of predetermined information, or acquires information received by the HMI 30 through an operation of the occupant. For example, the predetermined information to be notified to the occupant includes information related to traveling of the host vehicle M, such as information on the state of the host vehicle M and information on driving control. Information on the state of the host vehicle M includes, for example, the speed of the host vehicle M, an engine speed, a shift position, and the like. The predetermined information may include information for warning that there is a possibility of coming into contact with the target, and information for prompting a driving operation to avoid contact. The predetermined information may include information not related to the driving control of the host vehicle M, such as television programs, content (for example, movies) stored in a storage medium such as a DVD.

For example, the HMI controller 180 may generate an image including the predetermined information described above and cause a display device of the HMI 30 to display the generated image, and may generate a sound indicating the predetermined information and output the generated sound from a speaker of the HMI 30.

The traveling drive force output device 200 outputs a traveling drive force (torque) for traveling of a vehicle to drive wheels. The traveling drive force output device 200 includes, for example, a combination of an internal combustion engine, an electric motor, a transmission, and the like, and an electronic control unit (ECU) for controlling them. The ECU controls the constituents described above according to information input from the driving controller 160 or information input from the driving operator 80.

The brake device 210 includes, for example, a brake caliper, a cylinder that transmits hydraulic pressure to the brake caliper, an electric motor that generates hydraulic pressure to the cylinder, and a brake ECU. The brake ECU controls the electric motor according to the information input from the driving controller 160 or the information input from the driving operator 80 so that brake torque corresponding to a braking operation is output to each wheel. The brake device 210 may include a mechanism for transmitting hydraulic pressure generated by operating a brake pedal included in the driving operator 80 to the cylinder via a master cylinder as a backup. The brake device 210 is not limited to the configuration described above, and may be an electronically controlled hydraulic brake device that controls actuators according to the information input from the driving controller 160 and transmits the hydraulic pressure of the master cylinder to the cylinder.

The steering device 220 includes, for example, a steering ECU and an electric motor. The electric motor applies, for example, a force to a rack and pinion mechanism to change a direction of steering wheels. The steering ECU drives the electric motor according to information input from the driving controller 160 or information input from the driving operator 80 to change the direction of the steering wheels.

[Function of Image Processor]

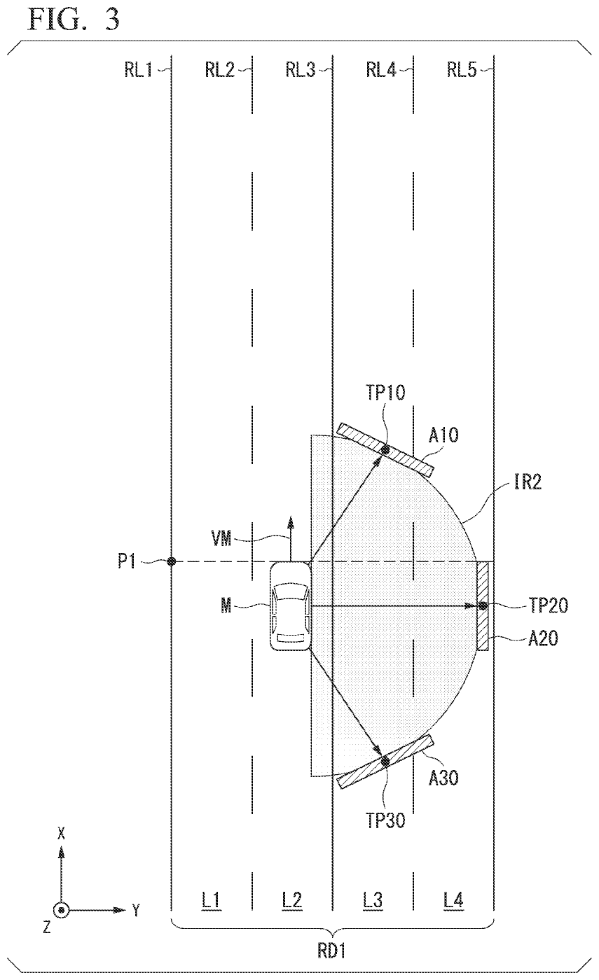

Hereinafter, functions of the image processor 120 will be specifically described. FIG. 3 is a diagram for describing the functions of the image processor 120. The example of FIG. 3 shows a road RD1 consisting of lanes L1 to L4. The lanes L1 and L2 are lanes in which vehicles can travel in the same direction (an X-axis direction in FIG. 3.), and the lanes L3 and L4 are oncoming lanes of the lanes L1 and L2. In FIG. 3, the lane L1 is partitioned by marking lines RL1 and RL2, the lane L2 is partitioned by marking lines RL2 and RL3, the lane L3 is partitioned by marking lines RL3 and RL4, and the lane L4 is partitioned by marking lines RL4 and RL5. In the example of FIG. 3, it is assumed that the host vehicle M travels in an extending direction of the lane L2 at a speed VM, and a reference position (for example, a front end) of the host vehicle M reaches a point P1.

The acquirer 122 acquires a camera image captured by the camera 10. The setter 124 sets one or more positions of interest to be subjected to image conversion by the converter 126 in the image acquired by the acquirer 122. For convenience of description, the imaging range IR2 photographed by a fish-eye camera attached to the right side of the vehicle M will be described as a reference in the following description. The setter 124 sets, as shown in FIG. 3, three positions of interest TP10 to TP30 of a right front, a right side, and a right rear as seen from the host vehicle M for the imaging range IR2. The number and angles of positions of interest are not limited to these. The position of interest may be set on the basis of, for example, a behavior of the host vehicle M obtained from the vehicle sensor 40 (for example, speed and angular speed), and alternatively (or additionally), it may be set on the basis of a shape of the road on which the host vehicle M travels, which is obtained by referring to map information stored in the storage 190 on the basis of positional information of the host vehicle M obtained from the vehicle sensor 40. In the example of FIG. 3, the positions of interest TP10 to TP30 are set on lanes on the right side of the traveling lane L2 of the host vehicle M.

The setter 124 sets partial images A10 to A30 centered on the positions of interest TP10 to TP30.

The converter 126 performs predetermined image processing such as image distortion correction processing on the partial images A10 to A30 set by the setter 124 to convert them into normalized images. Since a camera image captured by a fish-eye camera has more distortion as a distance from the center C2 of the imaging range IR2 increases, each of the partial images A10 to A30 also has a different degree of distortion depending on the distance and the direction (angle) from the center C2. Therefore, the converter 126 may adjust a degree of distortion correction according to the distance and direction from the center C2 of the photographing range IR2. The converter 126 synthesizes the partial images A10 to A30 subjected to the distortion correction processing and converts them into normalized images.

The target detector 128 detects a target present in the image by using the normalized images obtained by the conversion by the converter 126. When a target is detected, the target detector 128 may determine whether the target is a target that may deviate from the lane L2 in which the host vehicle M is traveling. A target that may cause the host vehicle M to deviate from the lane L2 is, for example, another vehicle approaching the host vehicle M. This is because, when the other vehicle is approaching the host vehicle M, the host vehicle M may deviate from the lane with a lane change or the like to avoid contact with the other vehicle. Targets that may cause the host vehicle M to deviate from the lane L2 include, for example, objects that have entered a traveling lane ahead of the vehicle M and the like. The target detector 128 detects a behavior of a situation of the target (for example, a position, a speed, a traveling direction, and the like) when the target is detected from the normalized images.

The setter 124 changes the position of interest on the basis of at least one of a result of the detection by the target detector 128 for the normalized image obtained from the past image frames (for example, an image frame immediately before or several frames before in time series) and the situation of the host vehicle M.

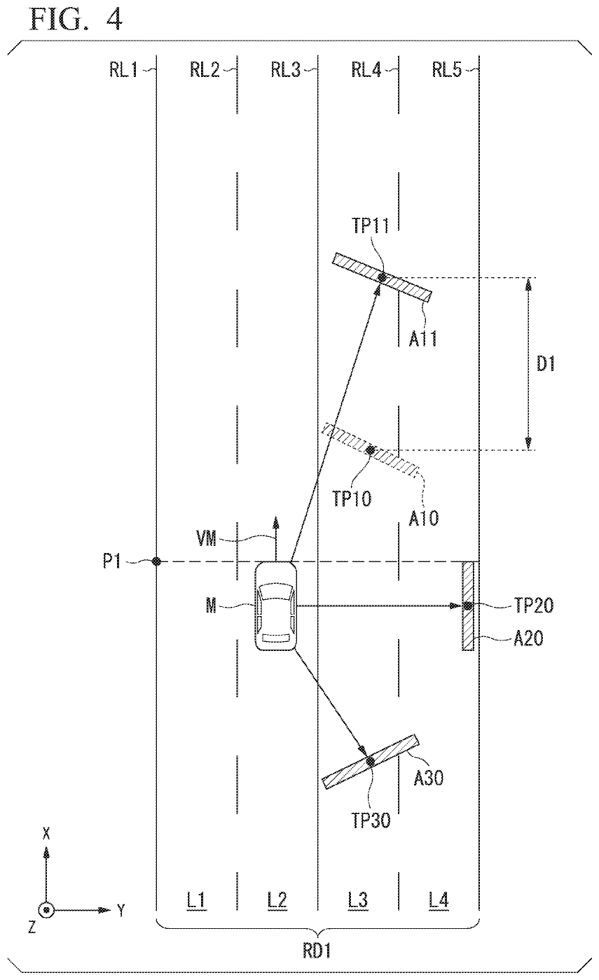

FIG. 4 is a diagram for describing changing of the position of interest. Although a position of interest TP10 is used for description below, similar processing may be performed on other positions of interest. For example, when a target is not detected by the target detector 128, the setter 124 sets, as shown in FIG. 4, a position of interest TP11 that is a predetermined distance D1 or more from the host vehicle M rather than the position of interest TP10 in the past as a new position of interest. The position of interest TP11 is, for example, a position in the vicinity of the lane L3 adjacent to the traveling lane L2 of the host vehicle M (within a predetermined distance from the lane L3). The position of interest TP11 may be, for example, a position in the vicinity of the farthest lane (for example, the lane L4) from the host vehicle M among lanes included in a photographing range of the camera image, or may be a position in the vicinity of the farthest lane among lanes that can be detected by the target detector 128. For example, when the previous position of interest TP10 is a position in a lane (for example, the lane L3), the setter 124 sets the position of interest TP11 at a position farther than the position when viewed from the host vehicle M in the same lane or a lane away from the host vehicle M. The farther position is, for example, a position above the previous position based on the camera image. The predetermined distance D1 may be variably set on the basis of the situation of the host vehicle M, the shape of the road, or the like, or may be a fixed value. The predetermined distance D1 may be set so that the distance increases stepwise according to the number of times detection processing is performed by the target detector 128. The setter 124 sets a partial image A11 centered on the position of interest TP11.

The setter 124 may add the position of interest TP11 instead of changing the position of interest TP11 from the position of interest TP10 in the past. As a result, the converter 126 performs image conversion by changing the previous partial image A10 to the partial image A11 at the time of a next conversion, thereby improving the accuracy of distortion correction at a distance and enabling a target at a distance to be detected at an earlier stage.

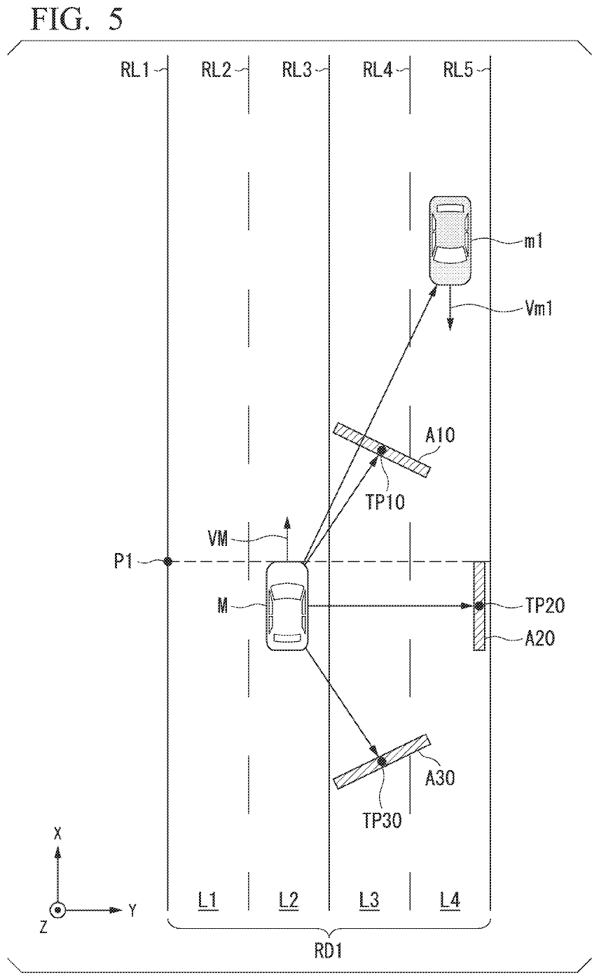

The setter 124 does not change the position of interest when the target detector 128 detects a predetermined target. A predetermined target is, for example, a vehicle approaching the host vehicle M, and is, more specifically, an oncoming vehicle. An oncoming vehicle is an example of the other vehicle approaching the host vehicle M, and is an example of a target that may cause the host vehicle M to deviate from the traveling lane according to a behavior thereof. FIG. 5 is a diagram for describing setting of a conversion center position when an oncoming vehicle is detected. The example of FIG. 5 differs from the example of FIG. 4 in that the other vehicle m1 is traveling in the lane L4 in the extending direction at a speed Vm1, which is an oncoming lane of the lane L2 in which the host vehicle M is traveling.

The target detector 128 detects the other vehicle m1 from a normalized image corresponding to the partial image A10. For this reason, the setter 124 does not change the position of interest TP10 in setting of a next position of interest. As a result, the other vehicle m1 can be detected by using an image converted by the same position of interest TP10 even when a next target is detected, and the other vehicle m1 can be tracked more reliably. Since the target is not detected in partial images corresponding to other positions of interest TP20 and TP30, the setter 124 may perform processing of changing the positions of interest TP20 and TP30 to positions farther than the current positions.

The setter 124 may move the position of interest in the horizontal direction or bring it closer according to the situation (position, behavior) of the host vehicle M and the situation (position, behavior) of the other vehicle m1. In this case, the setter 124 sets the position of interest so that the other vehicle m1 becomes a center of a partial image based on the future positions and behaviors of the host vehicle M and the other vehicle m1. As a result, the other vehicle m1 can be detected more reliably. The setter 124 may move the position of interest in the horizontal direction according to the angular speed of the vehicle M when the angular speed of the vehicle M is equal to or greater than a predetermined angle due to a right or left turn operation of the host vehicle M, and other orientation change operations such as a lane change. In this case, the setter 124 changes (horizontally moves) the position of interest according to the angular speed so that the position of interest is positioned near the road on which the vehicle M is to turn right if the host vehicle M is to turn right. As a result, it is possible to detect a target on the road on which the vehicle turns right or left more quickly and reliably.

In this manner, the setter 124 sets the position of interest when the predetermined target is not detected in the partial image set from the past camera image to a position a predetermined distance or more from the position of interest when the target is detected from the partial image set from the past camera image, thereby detecting a target at a distance more quickly and reliably. The setter 124 may return the position of interest to an original position (an initial position) when the target is detected in a partial image based on the position of interest at a distance, and bring the position of interest closer to the vicinity of the host vehicle M stepwise on the basis of the behavior of the host vehicle M or the other vehicle.

The driving controller 160 executes traveling control of controlling one or both of the steering and speed of the vehicle M on the basis of a result of processing by the image processor 120 so that the vehicle M does not come into contact with the target.

The HMI controller 180 causes the HMI 30 to output, for example, information on an area of interest and a partial image area, a result of target detection, information on driving control, and the like. This allows an occupant to ascertain details of the control by the host vehicle M more accurately.

[Processing Flow]

Next, a flow of processing executed by the vehicle control device 100 of the embodiment will be described. The processing of a flowchart below includes processing executed by the vehicle system 1, and may be repeatedly executed at predetermined timings.

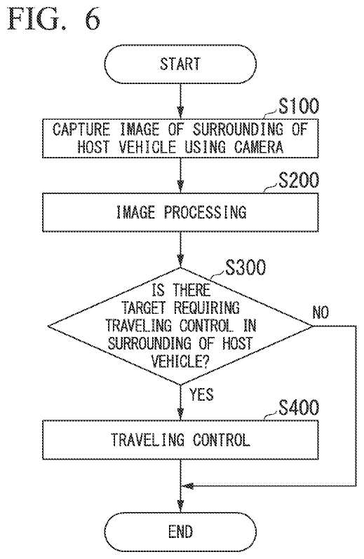

FIG. 6 is a flowchart which shows an example of a flow of processing executed by the vehicle control device 100. In the example of FIG. 6, the vehicle system 1 captures images of the surroundings of the host vehicle M with the camera 10 including a fish-eye camera (step S100). Next, the image processor 120 of the vehicle control device 100 acquires the captured image and executes predetermined image processing (step S200). Next, the determiner 140 determines whether a target requiring driving control (driving assistance) of the host vehicle M is present in the surroundings of the host vehicle M on the basis of a result of the processing by the image processor 120 (step S300). When it is determined that there is a target that requires driving control, the driving controller 160 executes driving control (for example, contact avoidance control, and the like) based on the situation of the target and the situation of the host vehicle M (step S400). As a result, processing of this flowchart will end. In the processing of step S300, when it is determined that there is no target that requires driving control, the processing of this flowchart will end.

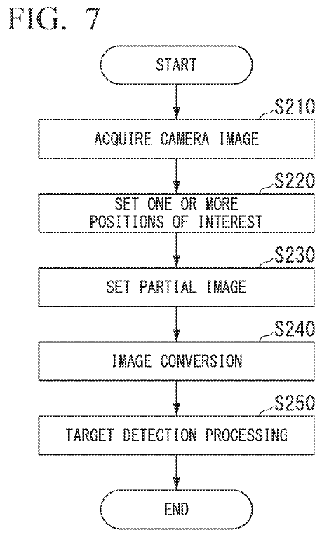

FIG. 7 is a flowchart which shows an example of a flow of image processing according to the embodiment. The example of FIG. 7 corresponds to the processing of step S200 described above. In the example of FIG. 7, the acquirer 122 acquires a camera image captured by a fish-eye camera (step S210). Next, the setter 124 sets one or more positions of interest from the camera image (step S220). Next, the setter 124 sets a partial image based on the set position of interest (step S230). Next, the converter 126 performs image processing such as distortion correction on the set partial image, and converts it into a normalized image (step S240). Next, the target detector 128 performs target detection processing on the basis of the normalized image (step S250). As a result, processing of this flowchart will end.

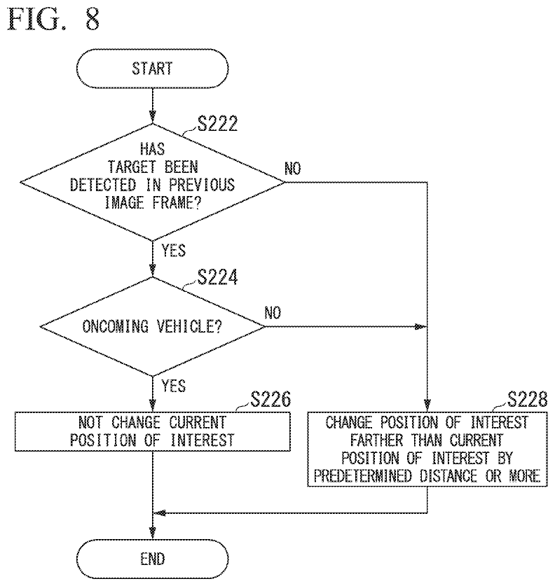

FIG. 8 is a flowchart which shows an example of processing of setting a position of interest. The example of FIG. 8 corresponds to the processing of step S220 described above. In the example of FIG. 8, it is assumed that a reference position of interest has already been set by setting a position of interest at a beginning of processing. In the example of FIG. 8, the setter 124 determines whether a target has been detected in the target detection processing in the previous image frame (step S222). If it is determined that the target has been detected, the setter 124 determines whether the detected target is an oncoming vehicle (step S224). When it is determined that the target is an oncoming vehicle, a current position of interest is not changed (the same position of interest is set) (step S226). When it is determined in the processing of step S222 that the target has not been detected, or when it is determined in the processing of step S224 that the target is not an oncoming vehicle, the setter 124 sets a position of interest farther than the current position of interest by a predetermined distance or more (step S228). As a result, processing of this flowchart will end.

According to the embodiment described above, the image processor 120 (an example of an image processing device) includes the acquirer 122 that acquires a first image captured in time series by a camera (an example of an imager) mounted on a mobile object, the setter 124 that sets one or more positions of interest based on a position of the mobile object in the first image, the converter 126 that converts the partial image set on the basis of the position of interest set by the setter 124 into a second image, and the target detector 128 that detects a target near the mobile object on the basis of the second image obtained by the conversion by the converter 126, in which the setter 124 can perform more appropriate image processing on the camera image by changing the position of interest on the basis of at least one of a result of the detection by the target detector 128 and the situation of a mobile object.

According to the embodiment, it is possible to perform target detection more quickly and accurately even on a wide range of captured images captured by the fish-eye camera to extract a partial image on the basis of a position of interest and perform image conversion (for example, distortion correction) and target detection. Therefore, the wide range of captured images obtained from the fish-eye camera can be effectively used for target detection processing for driving control such as driving assistance and automated driving, contact determination processing, and the like, and thus reliability of processing can be further improved.

The embodiment described above can be expressed as follows.

An image processing device includes a storage medium that stores an instruction readable by a computer, and a processor connected to the storage medium, and the processor executes the instruction readable by the computer, thereby acquiring a first image captured in time series by an imager mounted on a mobile object, setting one or more positions of interest based on a position of the mobile object in the first image, converting a partial image set on the basis of the set position of interest into a second image, detecting a target near the mobile object on the basis of the converted second image, and changing the position of interest on the basis of at least one of a detected result and a situation of the mobile object.

As described above, a mode for implementing the present invention has been described using the embodiments, but the present invention is not limited to such embodiments at all, and various modifications and replacements can be added within a range not departing from the gist of the present invention.

What is claimed is:

1. An image processing device comprising:
an acquirer configured to acquire a first image captured in time series by an imager mounted on a mobile object;
a setter configured to set one or more positions of interest based on a position of the mobile object in the first image;
a converter configured to convert a partial image set on the basis of the position of interest set by the setter into a second image; and
a target detector configured to detect a target near the mobile object on the basis of the second image obtained by the conversion by the converter,
wherein the setter changes the position of interest on the basis of at least one of a result of detection by the target detector and a situation of the mobile object.

2. The image processing device according to claim 1,
wherein the setter changes the position of interest when a predetermined target is not detected in the second image based on the past first image captured by the imager to a position farther than a position of interest when a target is detected from the second image by a predetermined distance or more.

3. The image processing device according to claim 1,
wherein the setter does not change the position of interest when a predetermined target is detected in the second image based on the past first image captured by the imager.

4. The image processing device according to claim 3,
wherein the predetermined target includes an oncoming mobile object that travels toward the mobile object.

5. The image processing device according to claim 1,
wherein, when an angular speed of the mobile object is equal to or greater than a predetermined angle, the setter causes the position of interest to move horizontally according to the angular speed.

6. The image processing device according to claim 2,
wherein the position farther by the predetermined distance or more includes a position within a predetermined distance from a lane adjacent to a lane in which the mobile object travels.

7. The image processing device according to claim 2,
wherein the position farther by the predetermined distance or more includes a position within a predetermined distance from a lane farthest from the mobile object among lanes detectable by the target detector.

8. The image processing device according to claim 1,
wherein the target is a target that may deviate from the lane in which the mobile object is traveling.

9. A mobile object control device comprising:
the image processing device according to claim 1, and
a driving controller configured to control one or both of steering and speed of the mobile object on the basis of a result of processing by the image processing device.

10. An image processing method comprising:
by a computer,
acquiring a first image captured in time series by an imager mounted on a mobile object;
setting one or more positions of interest based on a position of the mobile object in the first image;
converting a partial image set on the basis of the set position of interest into a second image;
detecting a target near the mobile object on the basis of the converted second image; and
changing the position of interest on the basis of at least one of a result of the detection and a situation of the mobile object.

11. A computer-readable non-transitory storage medium which has stored a program causing a computer to execute:
acquiring a first image captured in time series by an imager mounted on a mobile object;
setting one or more positions of interest based on a position of the mobile object in the first image;
converting a partial image set on the basis of the set position of interest into a second image;
detecting a target near the mobile object on the basis of the converted second image; and
changing the position of interest on the basis of at least one of a result of the detection and a situation of the mobile object.
